(19) United States
(12) Patent Application Publication
(10) Pub. No.: US 2013/0121889 A1
(43) Pub. Date: May 16, 2013

(54) OPTICAL REACTOR AND METHOD FOR MANUFACTURING THE SAME

(71) Applicant: Hisanao Usami, Ueda City (JP)

(72) Inventor: Hisanao Usami, Ueda City (JP)

(73) Assignee: SHINSHU UNIVERSITY, Matsumoto City, Nagano (JP)

(21) Appl. No.: 13/812,814

(22) PCT Filed: Jul. 29, 2011
(86) PCT No.: PCT/JP2011/004335

§ 371 Date: Jan. 28, 2013

(30) Foreign Application Priority Data
Aug. 3, 2010 (JP) 2010-174257

(51) Int. Cl. B01J 19/12

(52) U.S. Cl. CPC B01J 19/123
USPC 422/186.3; 422/186; 65/36

(57) ABSTRACT

An optical reactor configured such that a large number of particles 3 . . . formed of a glass material are accommodated in a glass tube 2, and a fluid L can flow through the glass tube 2 is characterized in that a contact portion between the glass tube 2 and the particles 3 . . . and a contact portion between the particles 3 . . . serve as welding surfaces J . . . each having a predetermined area so that light guides C are provided continuing to the glass tube 2 and the particles 3 . . . through the welding surfaces J. An photocatalyst layer 4 can be provided on the surfaces of the particles 3 . . . and an inner surface of the glass tube 2 except the welding surfaces J . . . . The glass tube 2 may be formed having a circular cross sectional shape or may be formed having a non-circular cross sectional shape.

### TECHNICAL FIELD

The present invention relates to an optical reactor configured such that a large number of particles formed of a glass material are accommodated in a glass tube and a fluid can flow through the glass tube and a method for manufacturing the same.

### BACKGROUND ART

A water purifying device (optical reactor) in which a large number of photocatalyst bodies constructed by coating the surface of particles formed of a glass material with titanium dioxide are accommodated in a container such as a glass tube, and a light beam (ultraviolet light) is applied to this photocatalyst bodies and is passed through water to be treated so as to purify the water to be treated has been known, and a purifying device is disclosed in Paten Literature 1 and a water treatment device is disclosed in Patent Literature 2.

The purifying device disclosed in Patent Literature 1 is composed of an outer tube whose both ends formed of a material transmitting ultraviolet light such as glass or the like are open, an inner tube accommodated in this outer tube and filled with photocatalysts each being covered with anatase-type titanium dioxide on the surface of glass beads and forming a treatment space to which the water to be treated is supplied between the outer tube and the inner tube, a glass filter provided on both end portions of the outer tube, an ultraviolet lamp arranged in the vicinity of the outer tube for applying ultraviolet light, and a reflective plate which reflects the ultraviolet light applied by the ultraviolet lamp toward the outer tube, while the water treatment device disclosed in Patent Literature 2 is configured such that a treatment tank which is a cylindrical container is mounted on a rotary shaft of a driving device and installed so as to rotate around a center axis at a speed of approximately 1 to 5 rotations per minute, a large number of photocatalyst bodies in which a spherical glass carrier is coated with coating having titanium dioxide made of anatase-type crystals as a main component are accommodated, and moreover, a rod-shaped ultraviolet lamp for applying light beams to this photocatalyst body is arranged, and an introduction pipe for the water to be treated is provided on one side of the treatment tank and a discharge pipe on the other side so that the water to be treated is introduced into/discharged from this treatment tank in a predetermined flow rate.

### CITATION LIST

### Patent Literature

Patent Literature 1: Japanese Unexamined Patent Application Publication No. 9-239358

Patent Literature 2: Japanese Unexamined Patent Application Publication No. 2000-117271

### SUMMARY OF INVENTION

### Technical Problem

However, the above-described prior-art water purifying devices (purifying device, water treatment device) have the following problems.

In any of the water purifying devices, treatment capacity (treatment efficiency) is improved by increasing a contact area of titanium dioxide (photocatalyst) with respect to the water to be treated by using a large number of photocatalyst bodies constructed by coating the surface of particles formed of a glass material with titanium dioxide. On the other hand, since ultraviolet light need to be applied to the photocatalyst, if a large number of photocatalyst bodies are filled in the glass tube as in Patent Literature 1, most of the photocatalyst bodies are hidden behind the other photocatalyst bodies. Therefore, the photocatalyst bodies behind the other are not activated and are not sufficient from the viewpoint of the increase of the emission area of ultraviolet light. After all, there is a limitation in the increase of treatment capacity (treatment efficiency).

On the other hand, in Patent Literature 2, since the treatment tank is rotated at a speed of approximately 1 to 5 rotations per minute, the photocatalyst bodies accommodated in this treatment tank are agitated at random. Therefore, though all the photocatalyst bodies can be activated averagely, the photocatalyst bodies behind the other also cannot be activated, similarly to the case of the cited document 1, and it is not sufficient from the viewpoint of the increase of the emission area of ultraviolet light. Moreover, a large-sized treatment tank and a driving device for rotating this treatment tank are needed, which incurs increase in a cost and the size of the entire device, and since electricity needs to be used, the device is poor in energy saving performance as well as in usability due to a limitation in places where the device can be used.

The present invention has an object to provide an optical reactor and a method for manufacturing the same which solved such problems encountered in the background art.

### Solution to Problem

An optical reactor 1 according to the present invention is, in order to solve the above-described problems, an optical reactor configured such that a large number of particles 3 . . . formed of a glass material are accommodated in a glass tube 2, and a fluid L can flow through the glass tube 2 and is characterized in that a contact portion between the glass tube 2 and the particles 3 . . . and a contact portion between the particles 3 serve as welding surfaces J . . . each having a predetermined area so that light guides C are provided continuing to the glass tube 2 and the particles 3 . . . through the welding surfaces J.

In this case, according to a preferred embodiment of the present invention, an photocatalyst layer 4 can be provided on the surfaces of the particles 3 . . . and an inner surface of the glass tube 2 except the welding surfaces J . . . . On the other hand, a single tube capable of applying a light beam to the outer peripheral surface from a light emitting portion 5 outside can be used for the glass tube 2. Regarding the glass tube 2, its sectional shape may be formed having a circular shape or a non-circular shape. At this time, the non-circular shape can include at least a polygon, a linear or curved elongated shape whose long side is three times or more of the short side. In the glass tube 2, a double tube in which an outer tube 2e and an inner tube 2i are disposed coaxially so that a light emitting portion 5 can be disposed at the center and the particles 3 . . . can be accommodated between the outer tube 2e and the inner tube 2i can be also used. On the other hand, the particles 3 . . . may be formed of a single glass material or may be configured such that on the surface of base bodies 3b . . . formed of a single glass material, coating layers 3c . . . made of a transparent material having a melting point lower than that of the glass material is provided. Moreover, the particles 3 . . . may be formed having a spherical shape having the same diameter. The optical reactor 1 can be used in a water purifying device M in which one end of the glass tube 2 becomes an inlet 2a for water La to be treated and the other end becomes an outlet 2b for treated water Lb.

On the other hand, a method for manufacturing the optical reactor 1 according to the present invention is characterized in that, in order to solve the above-described problems, when the optical reactor 1 in which a large number of the particles 3 . . . formed of a glass material are accommodated in the glass tube 2 and the fluid L can flow through the glass tube 2 is to be manufactured, after the particles 3 . . . are filled in the glass tube 2, the glass tube 2 filled with the particles 3 . . . is heated at a predetermined heating temperature Th so that the welding surfaces J . . . each having a predetermined area are generated on the contact portion between the glass tube 2 and the particles 3 . . . and the contact portion between the particles 3 . . . and light guides C continuing to the glass tube 2 and the particles 3 . . . are provided through the welding surfaces J . . . .

In this case, according to the preferred embodiment of the present invention, after the welding surfaces J . . . are generated on the contact portion between the glass tube 2 and the particles 3 . . . and the contact portion between the particles 3 . . . , an photocatalyst solution K is filled in the glass tube 2 and after that, the photocatalyst solution K is discharged from the glass tube 2 and the photocatalyst layer 4 can be provided on the surface of the particles 3 . . . and an inner surface of the glass tube 2 except the welding surfaces J . . . . Moreover, the welding surface J may be generated directly on the surfaces of the particles 3 . . . formed of a single glass material or the welding surface J may be so generated that the particles 3 . . . are configured by providing coating layers 3c . . . made of a transparent material having a melting point lower than that of the glass material on the surface of the base bodies 3b . . . formed of a single glass material, whereby the welding surface J is generated by the coating layers 3c . . . . If the welding surface J is to be generated directly on the surface of the particles 3 . . . formed of a single glass material, a material having a melting point higher than that of the material of the particles 3 . . . is preferably used as the material for the glass tube 2.

### Advantageous Effects of Invention

According to the above-described optical reactor 1 and the method for manufacturing the same according to the present invention, the following marked effects are exerted.

(1) The light guides C continuing to the glass tube 2 and the particles 3 . . . are provided through the welding surfaces J . . . by providing the welding surfaces J . . . each having a predetermined area on the contact portion between the glass tube 2 and the particles 3 . . . and the contact portion between the particles 3 . . . . Therefore, even if the large number of particles 3 . . . formed of a glass material are used and a light beam is applied from outside the glass tube 2, when the fluid L is made to flow through the inside of the glass tube 2, a contact area of the surfaces of the particles 3 . . . with the fluid L is increased, and a light application area on the surfaces of the particles 3 . . . can be also increased, and the treatment capacity (treatment efficiency) with respect to the fluid L can be markedly improved.

(2) When the optical reactor 1 is to be manufactured, after the particles 3 . . . are filled in the glass tube 2, by heating the glass tube 2 filled with the particles 3 . . . at the predetermined heating temperature Th, it is only necessary to generate the welding surfaces J . . . each having a predetermined area on the contact portion between the glass tube 2 and the particles 3 . . . and the contact portion between the particles 3 . . . . Thus, the optical reactor can be manufactured extremely easily with the smaller number of components, and cost and size reduction of the entire device can be realized, and since a power portion or the like is not needed, energy saving performance and usability are also excellent.

(3) According to a preferred embodiment, by providing the photocatalyst layer 4 on the surfaces of the particles 3 . . . and inner surface of the glass tube 2 except the welding surfaces J . . . , the water purifying device M in which one end of the glass tube 2 becomes the inlet 2a for the water La to be treated and the other end becomes the outlet 2b for the treated water Lb and the like can be easily constructed. Moreover, the treatment capacity (treatment efficiency) when the water La to be treated is to be purified can be markedly improved, and the water purifying device M capable of cost and size reduction and the like can be provided.

(4) According to the preferred embodiment, by using a single tube capable of applying a light beam to the outer peripheral surface from the light emitting portion 5 outside as the glass tube 2, the simpler and more inexpensive optical reactor 1 can be constructed.

(5) According to the preferred embodiment, by forming the glass tube 2 having a circular sectional shape, the most popular shape can be formed and the glass tube can be manufactured easily and with a low cost.

(6) According to the preferred embodiment, by forming the glass tube 2 having a non-circular sectional shape and also by having this non-circular shape include at least a polygon, a linear or curved elongated shape whose long side is 3 times or more of the short side, various applications and purposes and moreover, the types, shapes and the like of the light emitting portion 5 can be flexibly handled, whereby improvement and optimization of the treatment efficiency can be easily realized.

(7) According to the preferred embodiment, by using the double tube in which the outer tube 2e and the inner tube 2i are coaxially arranged so that the light emitting portion 5 can be disposed at the center and the particles 3 . . . can be accommodated between the outer tube 2e and the inner tube 2i, a light beam can be applied from the light emitting portion 5 disposed at the center to each of the particles 3 . . . arranged in a ring shape in directions of 360°, and thus, a substantial light application area (light application efficiency) to the particles 3 . . . can be further improved.

(8) According to the preferred embodiment, by forming the particles 3 . . . by a single glass material, the welding surfaces J . . . can be generated directly on the surfaces of the particles 3 . . . , and thus, the light guides C with less loss can be easily provided.

(9) According to the preferred embodiment, by using a material having a melting point higher than that of the material of the particles 3 . . . for the material of the glass tube 2, even if the welding surfaces J . . . are generated directly on the surfaces of the particles 3 . . . , a bad influence such as unnecessary deformation of the glass tube 2 or the like can be avoided.

(10) According to the preferred embodiment, by configuring the particles 3 . . . by providing the coating layers 3c . . . made of a transparent material having a melting point lower than that of the glass material on the surfaces of the base bodies 3b formed of a single glass material, the welding surfaces J . . . can be generated by the coating layers 3c . . . Thus, the optical reactor 1 can be manufactured at a lower heating temperature and particularly, unnecessary dissolution of the base bodies 3b . . . can be avoided.

(11) According to the preferred embodiment, by forming the particles 3 . . . each having a spherical shape with the same diameter, the optical reactor 1 with less variation and high quality and homogeneity in treatment performance can be obtained.

(12) According to the preferred embodiment, when the optical reactor 1 is to be manufactured, after the welding surfaces J . . . are generated on the contact portion between the glass tube 2 and the particles 3 . . . and the contact portion between the particles 3 . . . , the photocatalyst solution K is filled in the glass tube 2 and after that, the photocatalyst solution K is discharged from the glass tube 2 and by providing the photocatalyst layer 4 on the surface of the particles 3 . . . and an inner surface of the glass tube 2 except the welding surfaces J . . . , the uniform photocatalyst layer 4 can be easily provided on the surfaces of the particles 3 . . . and the inner surface of the glass tube 2.

### BRIEF DESCRIPTION OF INVENTION

FIG. 1 is a principled sectional configuration diagram on front view of an optical reactor according to a preferred embodiment of the present invention.

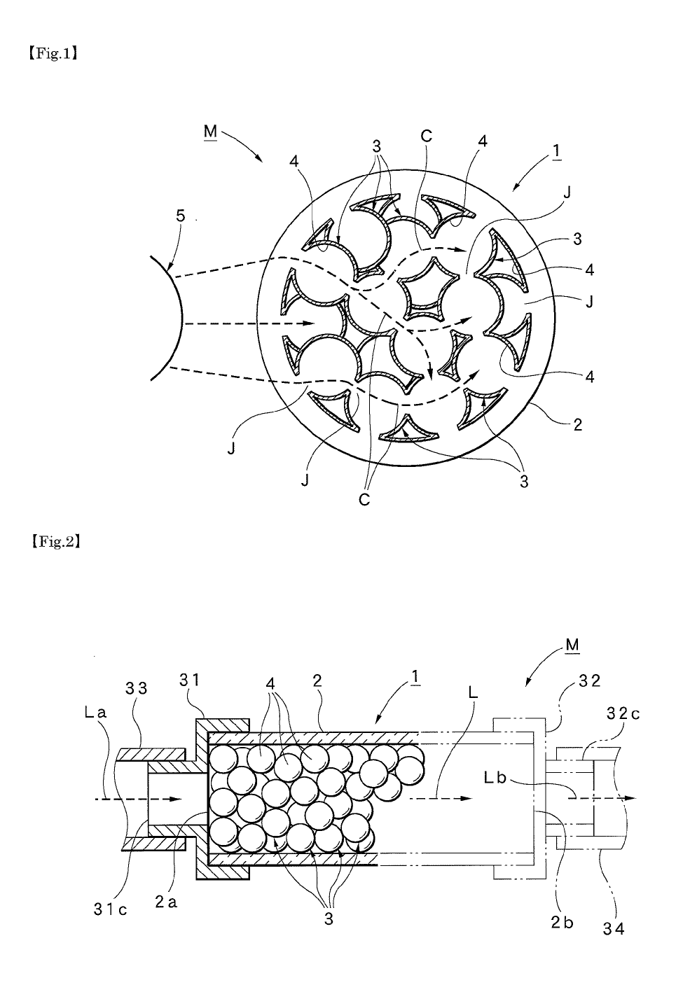

FIG. 2 is a side sectional view from which a part of the optical reactor is omitted.

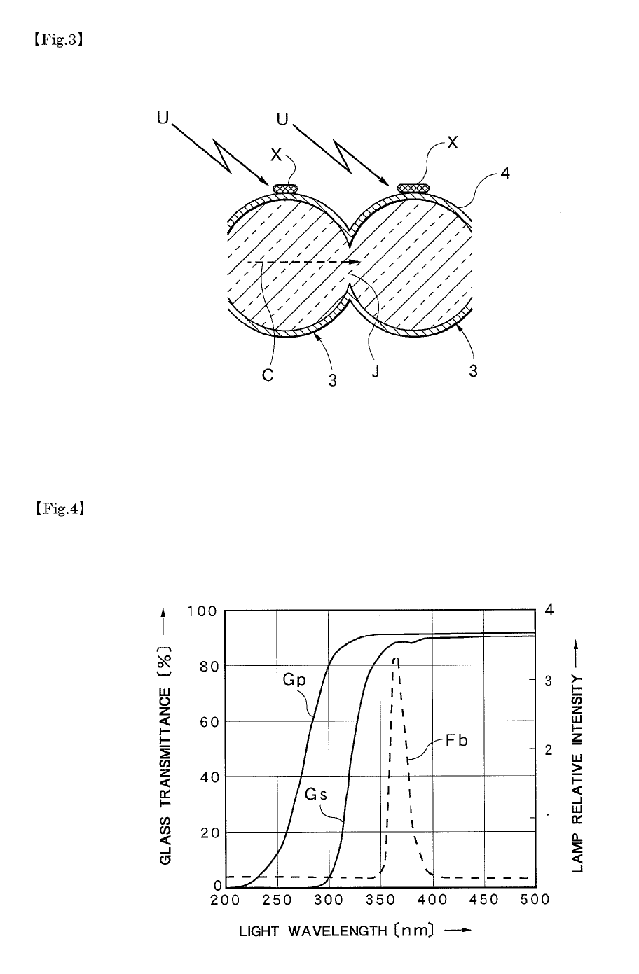

FIG. 3 is an action explanation diagram including an extracted and enlarged section of a part of particles in the optical reactor.

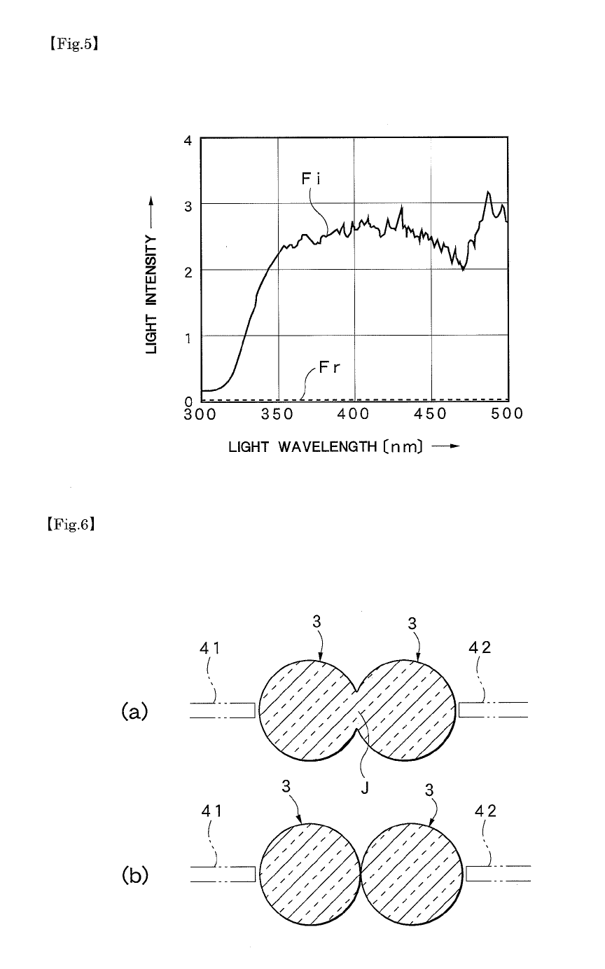

FIG. 4 is a transmittance characteristic diagram of a glass used in the optical reactor with respect to a light wavelength.

FIG. 5 is a light intensity characteristic diagram between particles in the optical reactor with respect to the light wavelength.

FIG. 6 is an explanatory diagram on measurement conditions when the optical intensity characteristic illustrated in FIG. 4 is measured.

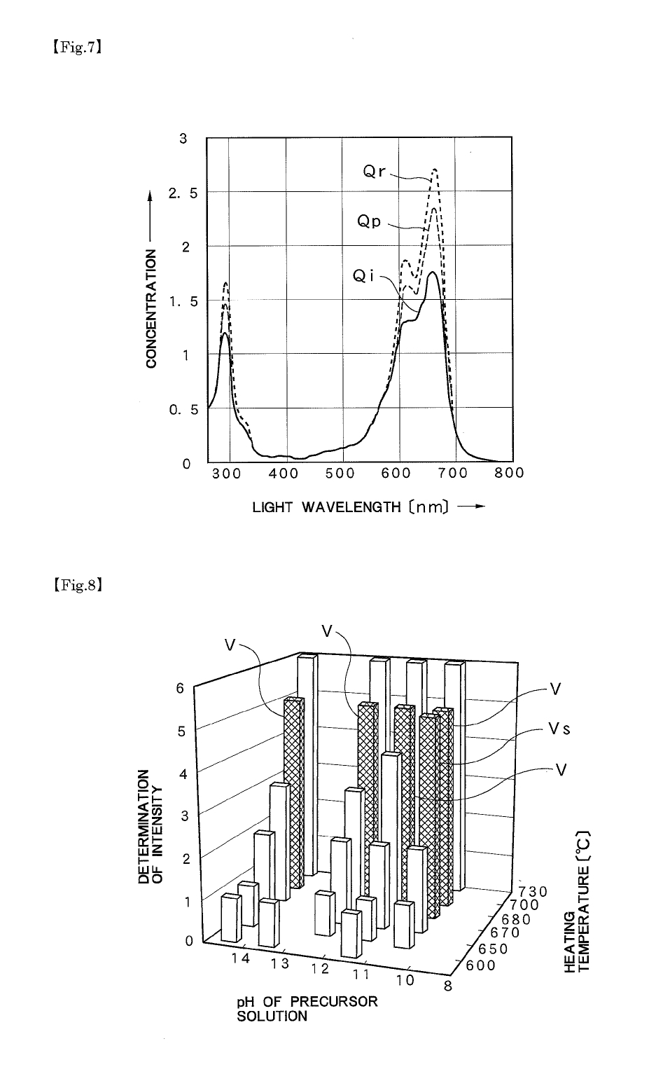

FIG. 7 is a characteristic diagram illustrating a treatment result of a liquid to be treated by the optical reactor.

FIG. 8 is a characteristic diagram for evaluation of a coating layer used for the particles in the optical reactor.

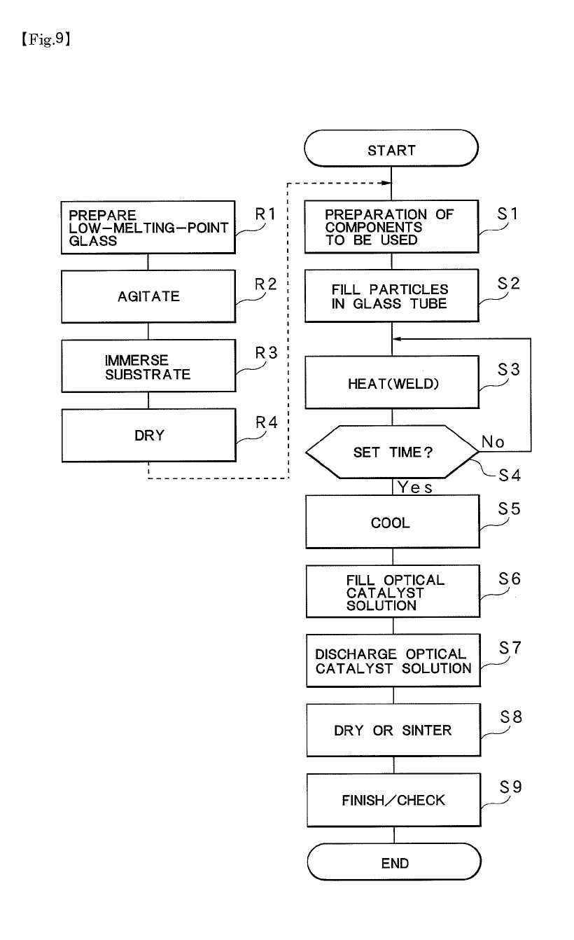

FIG. 9 is a flowchart for explaining a method for manufacturing the optical reactor.

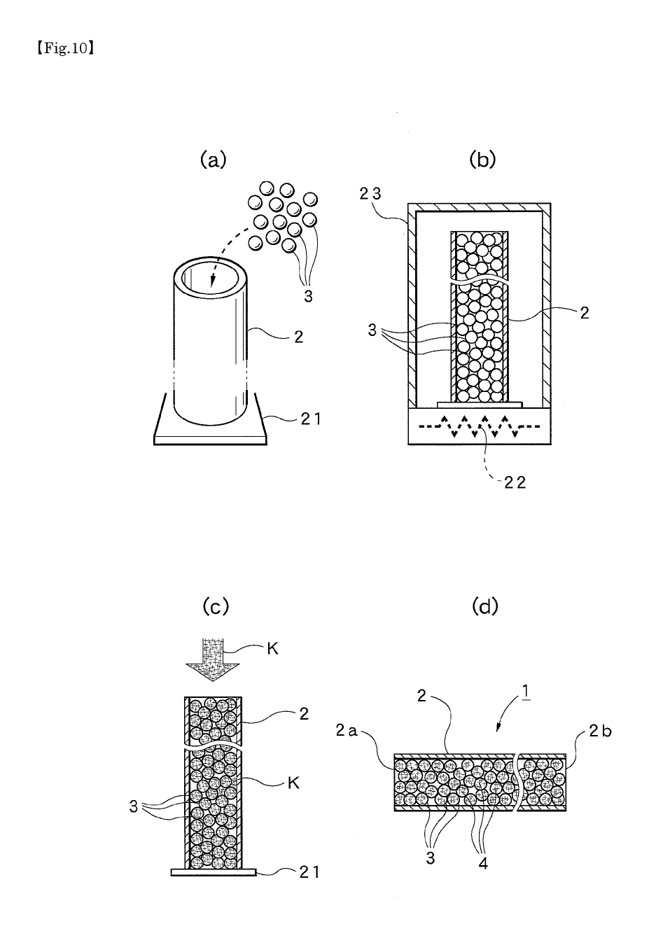

FIG. 10 is a schematic process diagram for explaining the method for manufacturing the optical reactor.

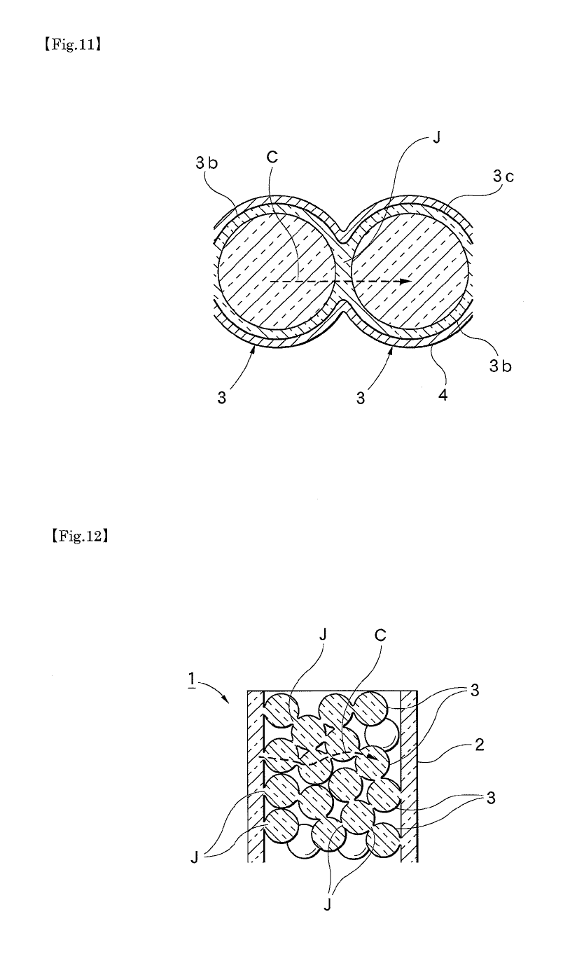

FIG. 11 is a sectional view of a part of the particles in the optical reactor according to a modified embodiment of the present invention.

FIG. 12 is a side sectional view illustrating a part of the optical reactor according to another modified embodiment of the present invention.

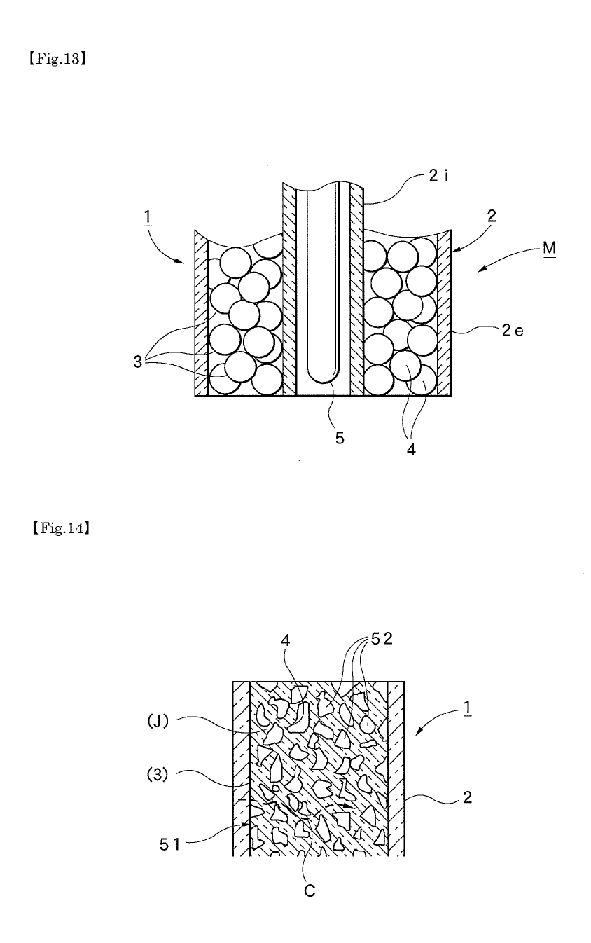

FIG. 13 is a side sectional view illustrating a part of the optical reactor according to another modified embodiment of the present invention.

FIG. 14 is a side sectional view illustrating a part of the optical reactor according to another modified embodiment of the present invention.

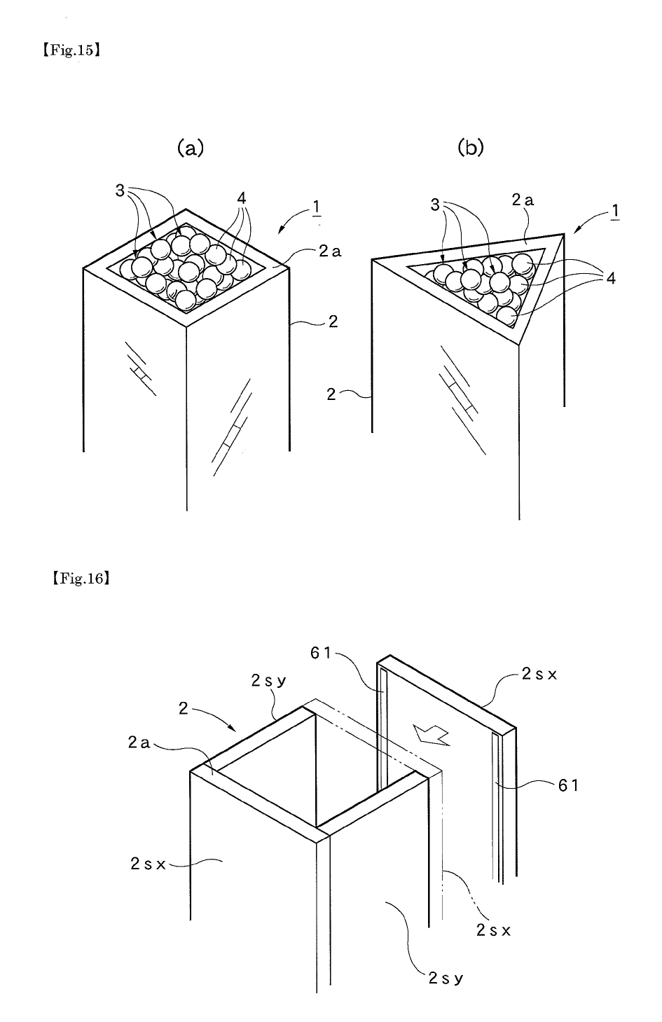

FIG. 15 is a perspective view illustrating a part of the optical reactor according to another modified embodiment of the present invention.

FIG. 16 is an explanatory diagram of assembly of a glass tube of the optical reactor according to another modified embodiment of the present invention.

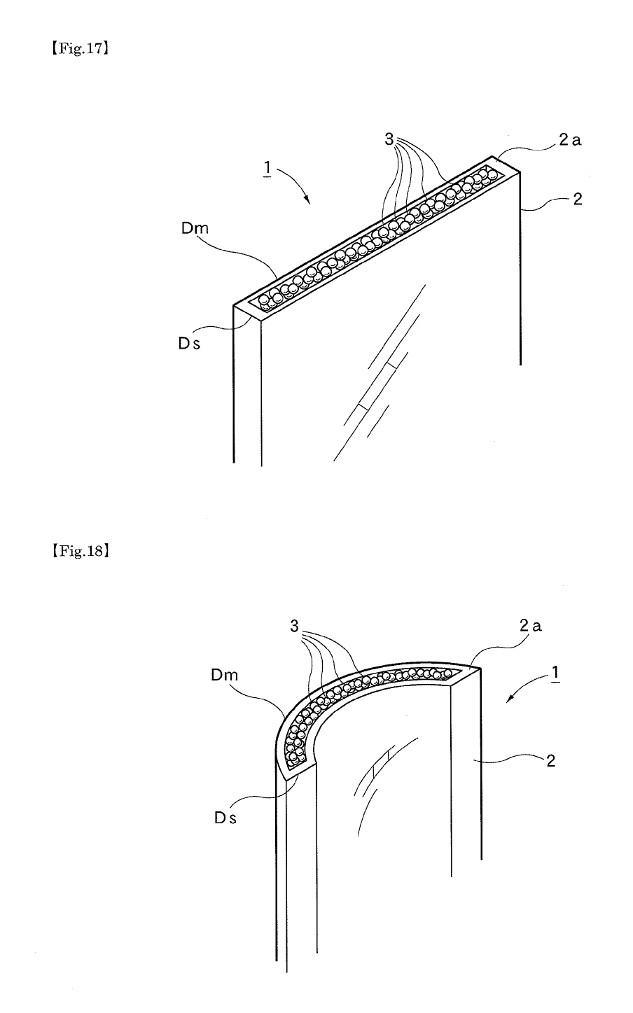

FIG. 17 is a perspective view illustrating a part of the optical reactor according to another modified embodiment of the present invention.

FIG. 18 is a perspective view illustrating a part of the optical reactor according to another modified embodiment of the present invention.

### REFERENCE SIGNS LIST

1: Optical reactor, 2: Glass tube, 2e: Outer tube, 2i: Inner tube, 2a: Inlet, 2b: Outlet, 3: Particle, 3b: Base body, 3c: Coating layer, 4: Photocatalyst layer, 5: Light emitting portion, L: Fluid, La: Water to be treated, Lb: Treated water, J: Welding surface, C: Light guide, M: Water purifying device, K: Photocatalyst solution

### DESCRIPTION OF EMBODIMENTS

Subsequently, a most preferred embodiment according to the present invention will be described in detail on the basis of the attached drawings.

First, a configuration of an optical reactor 1 according to this embodiment will be specifically described by referring to FIGS. 1 to 7.

The optical reactor 1 according to this embodiment is basically configured, as illustrated in FIGS. 1 and 2, such that a large number of particles 3 . . . formed of a glass material are accommodated in a glass tube 2 and a fluid L can flow through the glass tube 2 and particularly a contact portion between the glass tube 2 and the particles 3 . . . and a contact portion between the particles 3 . . . are provided as welding surfaces J each having a predetermined area so that light guides C continuing to the glass tube 2 and the particles 3 . . . are provided through the welding surfaces J . . . . Therefore, as illustrated in FIGS. 1 and 3, since the contact portion between the glass tube 2 and the particles 3 . . . and the contact portion between the particles 3 and 3 are generated as the welding surfaces J . . . , respectively, light applied to an outer peripheral surface of the glass tube 2 is, as illustrated as dotted lines, transmitted through the light guides C continuing to the particles 3 . . . and is efficiently guided without light intensity being largely deteriorated with respect to most of the particles 3 . . . in the glass tube 2.

This embodiment exemplifies a case in which the optical reactor 1 as above is used for a water purifying device M as in FIG. 2. Therefore, the optical reactor 1 according to this embodiment has an photocatalyst layer 4 using anatase-type titanium dioxide (TiO₂) provided on the surfaces of the particles 3 . . . and an inner surface of the glass tube 2 except the welding surfaces J . . . . Thus, the exemplified optical reactor 1 has, as illustrated in FIG. 2, one end of the glass tube 2 becoming an inlet 2a for water La to be treated and the other end becoming an outlet 2b for treated water Lb.

In this case, the glass tube 2 is, as illustrated in FIG. 1, a single tube having a circular sectional shape capable of applying a light beam to the outer peripheral surface from a light emitting portion 5 outside and is formed by using heat resistant glass such as Pyrex (registered trademark) glass. Therefore, regarding the glass tube 2 to be used, the intended glass tube 2 can be easily obtained by cutting a length to be used from a long glass pipe having a predetermined diameter. In this embodiment, Pyrex (registered trademark) glass is used for the glass tube 2. By forming the glass tube 2 having a circular sectional shape as above, the most popular shape can be obtained, and there is an advantage that the glass tube can be manufactured easily and with a low cost.

Moreover, the particle 3 is formed having a spherical shape having the same diameter by using the glass material. By using the particles 3 . . . each having a spherical shape having the same diameter, the optical reactor 1 with less variation in treatment performance and high quality and homogeneity can be obtained. As the glass material for the particles, soda glass used for general-purpose panes and the like can be used. On the other hand, as the light emitting portion 5 outside which becomes a light source for an ultraviolet irradiated light for activating an photocatalyst in the photocatalyst layer 4, a black lamp can be used.

FIG. 4 is evaluation data of Pyrex (registered trademark) glass, soda glass, and a black lamp and shows transmittance characteristics to light wavelength of each glass and emission spectrum characteristics of the black lamp (10 [W]). In FIG. 4, a curve Gp indicates transmittance of Pyrex (registered trademark) glass, a curve Gs indicates transmittance of soda glass, and a curve Fb indicates emission spectrum of a black lamp. The Pyrex (registered trademark) glass ensures transmittance of 85 to 95 [%] at the light wavelength of 300 [nm] or more, and the soda glass ensures transmittance of 85 to 95 [%] at the light wavelength of 350 [nm] or more. Moreover, the relative light intensity of the lamp is present between 350 and 400 [nm] of the light wavelength. Therefore, even if the inexpensive soda glass is used for the particles 3 . . . and the black lamp is used for the light source of ultraviolet irradiated light, required and sufficient light guiding performance can be ensured.

FIG. 5 shows light intensity characteristics to light wavelength between the particles 3 . . . . In FIG. 5, a curve Fi indicates the light intensity characteristics if the welding surface J is provided between two particles 3 and 3 and a measurement condition at this time is shown in FIG. 6(a). Moreover, a curve Fr indicates light intensity characteristics if two independent particles 3 and 3 are simply brought into contact with each other, and the measurement condition at this time is shown in FIG. 6(b). As illustrated in FIGS. 6(a) and 6(b), the light intensity characteristics were measured by having one end of an incident side optical fiber 41 opposed to one end side in an alignment direction of the two juxtaposed particles 3 and 3, having one end of an outgoing side optical fiber 42 opposed to the other end side in the alignment direction, allowing light of a light emitting source incident to the other end of the incident side optical fiber 41, and by having a spectrometer faced with the other end of the outgoing side optical fiber 42. As illustrated in FIG. 6(b), almost no light is transmitted in any wavelength areas by only bringing the independent particles 3 and 3 into contact. However, as in this embodiment illustrated in FIG. 6(a); by generating the welding surface J between the particles 3 and 3, sufficient light transmittance (light guiding performance) can be confirmed at least at the light wavelength of 350 [nm] or more.

As described above, by using heat resistant glass such as Pyrex (registered trademark) glass and the like for the glass tube 2 and by using soda glass for the particles 3 . . . , the material of the glass tube 2 has a melting point higher than that of the material of the particles 3 . . . as a result. Therefore, even if the welding surfaces J are generated directly on the surfaces of the particles 3 . . . , a bad influence such as unnecessary deformation of the glass tube 2 can be avoided. Moreover, since the particles 3 . . . formed of a single glass material are welded together, the welding surfaces J . . . can be generated directly on the surfaces of the particles 3 . . . , and the light guides C with less loss can be easily provided. Moreover, since a single tube capable of applying a light beam to the outer peripheral surface from the light emitting portion 5 outside is used for the glass tube 2, the simpler and more inexpensive optical reactor 1 can be constructed.

On the other hand, the photocatalyst layer 4 is provided by coating the surfaces of the particles 3 . . . and the inner surface of the glass tube 2 except the welding surfaces J . . . . Since the above-described titanium dioxide is used for the photocatalyst layer 4, actions of air cleaning, water purification, deodorizing, sterilization, antifouling and the like which are known actions are performed by oxidation reaction and dissolution reaction by the photocatalyst. That is, as illustrated in FIG. 3, if a contaminant X is in contact with the surface of the photocatalyst layer 4 provided on the particle 3 (soda glass), the contaminant X is purified on the condition that an excitation light beam (ultraviolet light) U is applied at the same time. Particularly, in the case of a liquid, the purifying action satisfying this condition becomes remarkably lower than a gas, and actually in the case of a liquid, a treatment capacity of 1000 times of that of a gas is considered to be necessary. Therefore, the increase of a substantial contact area where the contaminant X is brought into contact with the surface of the photocatalyst layer 4 and the increase of the substantial application area on which the excitation light U is applied at the same time are important objects in improvement of the treatment capacity of the water purifying device 1.

In the optical reactor 1 according to this embodiment, the light guides C continuing to the glass tube 2 and the particles 3 . . . through the welding surfaces J . . . are provided by forming the contact portion between the glass tube 2 and the particles 3 . . . and the contact portion between the particles 3 . . . as the welding surfaces J . . . each having a predetermined area. Therefore, even if the large number of particles 3 . . . formed of a glass material are used and light is applied from the outside of the glass tube 2, if the fluid L is allowed to flow through the glass tube 2, the contact area on the surface of the particles 3 . . . with respect to the fluid L and the application area to the surfaces of the particles 3 . . . can be increased at the same time, and the treatment capacity (treatment efficiency) with respect to the fluid L can be markedly improved. Moreover, since the photocatalyst layer 4 using titanium dioxide is provided on the surfaces of the particles 3 . . . and the inner surface of the glass tube 2 except the welding surfaces J . . . , the water purifying device M in which the one end of the glass tube 2 becomes the inlet 2a for the water La to be treated and the other end becomes the outlet 2b for the treated water Lb and the like can be easily constructed, the treatment capacity (treatment efficiency) when the water La to be treated is to be purified can be markedly improved, and the water purifying device M capable of cost and size reduction and the like can be provided.

FIG. 7 illustrates a treatment result of the water La to be treated by the optical reactor 1 (water purifying device M). FIG. 7 is a treatment result when methylene blue of 50 [mM], pH 3.0, and 4 [mL] was accommodated in the optical reactor 1 and ultraviolet light from the black lamp was applied to the peripheral surface of the glass tube 2. In FIG. 7, a curve Qr indicates initial concentration of methylene blue (water La to be treated) and a curve Qi indicates concentration of methylene blue (treated water Lb) after the treatment. Moreover, a curve Qp indicates a comparative example if the welding surfaces J . . . are not provided and shows a result when the independent particles 3 . . . are filled in the glass tube 2 as they are similarly to the prior-art case and treated on the same condition as that of the case of Qi. If the optical reactor 1 (water purifying device M) according to this embodiment is used (Qi), a considerably higher water purification effect than the prior-art case (Qp) can be obtained.

Subsequently, the method for manufacturing the optical reactor 1 according to this embodiment will be described by referring to a flowchart illustrated in FIG. 9 and FIGS. 10(a) to 10(d).

First, the glass tube 2 and a large number of particles 3 . . . which are components to be used are prepared, and an photocatalyst solution K for providing the photocatalyst layer 4 is prepared (Step S1). The photocatalyst solution K is mainly composed of titanium dioxide and a necessary binder and the like can be contained. When preparation is completed, as illustrated in FIG. 10(a), the glass tube 2 is made to stand on a substrate jig 21, and the particles 3 . . . are filled inside the glass tube 2 by inputting them through an upper-end opening of the glass tube 2 (Step S2). Subsequently, as illustrated in FIG. 10(b), the glass tube 2 filled with the particles 3 . . . is accommodated inside a heating furnace 23 heated by a heater 22 and is subjected to heating treatment only for heating time Zh set in advance under a temperature environment at a heating temperature Th [° C.] set in advance (Steps S3 and S4). As a result, the surfaces of the glass tube 2 and the particles 3 . . . are dissolved by the heating temperature Th [° C.], and the contact portion between the glass tube 2 and the particles 3 . . . and the contact portion between the particles 3 . . . are welded, respectively, whereby the welding surfaces J having a predetermined area are generated. In this case, if the heating temperature Th [° C.] is too low, insufficient dissolution occurs, and the sufficient and favorable welding surfaces J cannot be obtained. Alternatively, if the heating temperature Th [° C.] is too high, dissolution occurs excessively, and a favorable internal shape cannot be obtained and also a channel becomes narrow. Therefore, for the heating temperature Th [° C.] and the heating time Zh, optimal values are preferably set by experiments and the like. In the exemplified case, it is preferable that the heating temperature Th [° C.] is approximately 600 to 700 [° C.]. As a result, the light guides C continuing to the glass tube 2 and the particles 3 . . . through the welding surfaces J . . . are provided. When the heating time Zh has elapsed, the glass tube 2 is taken out of the heating furnace 23 and cooled to a normal temperature by natural cooling (Step S5).

Subsequently, as illustrated in FIG. 10(c), the photocatalyst solution K is poured from the upper end opening of the glass tube 2, and the photocatalyst solution K is filled in the glass tube 2 (Step S6). At this time, vibration or the like is given as necessary so that the photocatalyst solution K penetrates into gaps between the particles 3 . . . and the like. On the other hand, when a predetermined time elapsed, the photocatalyst solution K is discharged out of the glass tube 2 (Step S7). Then, the glass tube 2 containing the particles 3 . . . is dried or sintered after the photocatalyst solution K is discharged (Step S8). As a result, the photocatalyst layer 4 using titanium dioxide can be provided on the surfaces of the particles 3 . . . and the inner surface of the glass tube 2 except the welding surfaces J . . . . By the method as described above, the uniform photocatalyst layer 4 can be easily provided on the surfaces of the particles 3 . . . and the inner surface of the glass tube 2. By repeating Steps S6 to S8 as necessary, the film thickness (layer thickness) of the photocatalyst layer 4 can be adjusted. After that, the substrate jig 21 is removed, finishing is performed such that the unnecessary photocatalyst layer 4 adhering to the end face of the glass tube 2 and the outer peripheral surface and the like is removed. Moreover, by checking light conductivity and the like, the optical reactor 1 illustrated in FIG. 10(d) can be obtained (Step S9).

By attaching caps 31 and 32 illustrated in FIG. 2 for closing the both-end openings of the obtained optical reactor 1, the water purifying device M can be configured. Each of the caps 31 and 32 has connection openings 31c and 32c protruding outward at the center, and water distributing pipes 33 and 34 for allowing the water La to be treated to flow into the optical reactor 1 or the treated water Lb to flow out of the inside of the optical reactor 1 can be connected to each of the connection openings 31c and 32c, respectively. As a result, the water purifying device M in which one end of the glass tube 2 becomes the inlet 2a for the water La to be treated, and the other end becomes the outlet 2b for the treated water Lb can be obtained.

According to the method for manufacturing the optical reactor 1 as above, after the particles 3 . . . are filled in the glass tube 2, by heating the glass tube 2 filled with the particles 3 . . . at the predetermined heating temperature Th, the welding surfaces J . . . each having the predetermined area are generated on the contact portion between the glass tube 2 and the particles 3 . . . and the contact portion between the particles 3 . . . . Thus, the optical reactor can be manufactured extremely easily by the smaller number of components, and the cost and size reduction of the entire body can be realized, and since a power portion or the like is not needed, energy saving performance and usability are also excellent.

Subsequently, a method of using the optical reactor 1 (water purifying device M) according to this embodiment and actions will be described by referring to each figure.

If the optical reactor 1 is to be used as the water purifying device M, as illustrated in FIG. 1, the light emitting portion 5 using the black lamp emitting ultraviolet lights is oppositely disposed on the peripheral surface of the glass tube 2 in the optical reactor 1. As a result, the ultraviolet lights emitted from the light emitting portion 5 are applied to the peripheral surface of the glass tube 2. FIG. 1 illustrates one unit of the light emitting portion 5 for convenience, but a configuration in which a plurality of light emitting portions 5 are arranged around the optical reactor 1 or a reflective plate having a semicircular section is arranged at a position opposite to the peripheral surface of the glass tube 2 and a position on the side opposite to the light emitting portion 5 can be employed. On the other hand, since the welding surfaces J . . . are generated between the glass tube 2 and the particles 3 . . . and between the particles 3 . . . , respectively, and the light guides C continuing through the welding surfaces J . . . are provided, the ultraviolet lights incident from the outer peripheral surface of the glass tube 2 pass through the light guides C indicated by the dotted-line arrows in FIG. 1 and guided to each of the particles 3 . . . and applied to the back surface of the photocatalyst layer 4 provided on the surface of each of the particles 3 . . . from the inside of each of the particles 3 . . . .

On the other hand, into the glass tube 2 in the optical reactor 1, as illustrated in FIG. 2, the contaminated water La to be treated, for example, flows through the inlet 2a on the one end and passes through the glass tube 2. At this time, the water La to be treated flows in contact with the photocatalyst layer 4 provided on the surfaces of the large number of particles 3 . . . present inside the glass tube 2 and at the same time, since the ultraviolet lights are applied to the photocatalyst layer 4 as excitation light from the inside in most of the particles 3 . . . and the photocatalyst layer 4 is activated, contamination in the water or harmful dissolved matters such as various environmental hormones, dioxin, trihalomethane, germs and the like, for example, are efficiently dissolved and made harmless by oxidation and decomposition reaction by the photocatalyst layer 4. Then, the treated water Lb after being treated flows out through the outlet 2b on the other end directly or through a strainer, not shown.

Subsequently, various optical reactors 1 . . . according to modified embodiments of the present invention will be described by referring to FIGS. 11 to 18 including FIGS. 8 and 9.

In FIG. 11, the particles 3 . . . are configured by providing coating layers 3c . . . each made of a transparent material having a melting point lower than that of the glass material on the surfaces of base bodies 3b . . . formed of a single glass material. In this case, the particles 3 to be used can be manufactured in advance by Steps R1 to R4 illustrated in FIG. 9. That is, first, Na₂Si₃ (0.5 M) in 58 [weight %] and HCl (1 M) in 42 [weight %] are blended as a material for generating a low-melting-point glass and sufficiently agitated so as to prepare a precursor solution (Steps R1 and R2). Then, the base bodies 3b . . . formed by a single glass material are immersed in the precursor solution and after that, taken out and dried (Steps R3 and R4). As a result, the particles 3 . . . having the coating layers 3c . . . on the surfaces of the base bodies 3b . . . can be obtained.

Then, by manufacturing the optical reactor 1 through Steps S1 to S9 illustrated in FIG. 9 by using these particles 3 . . . , as illustrated in FIG. 11, the welding surfaces J by the coating layers 3c . . . are generated. As described above, by using the particles 3 . . . in which the coating layers 3c . . . are provided on the surfaces of the base bodies 3b . . . , the welding surfaces J . . . can be generated by the coating layers 3c . . . , and thus, the optical reactor 1 can be manufactured at a lower heating temperature. Particularly, since unnecessary dissolution of the base bodies 3b . . . can be avoided, the shapes of the base bodies 3b . . . can be maintained as they are.

FIG. 8 shows an evaluation characteristic diagram of the particles 3 . . . in which the coating layers 3c . . . are provided or particularly a characteristic diagram for evaluating mechanical strength. In determination of the strength, “1” indicates no welding, “2” indicates that it can be removed but there is a welding mark, “3” indicates that welding is done but it removes if it is being dropped from 10 [cm] above the floor, “4” indicates that welding is done but it removes if it is dropped from 50 [cm] above the floor, “5” indicates that welding is done and it is not removed even if it is dropped from 50 [cm] above the floor, and “6” indicates that the melting point of the base bodies 3b . . . is exceeded and the original shape is lost. Therefore, by considering the result in FIG. 8, the condition given the reference character V in FIG. 8 indicates a favorable welding condition and particularly the condition given the reference character Vs, that is, the heating temperature 680 [° C.] and pH 10 are optimal.

FIG. 12 illustrates the optical reactor 1 in which the photocatalyst layer 4 is not provided. That is, the intermediate product obtained at Step S5 in FIG. 9 is used as it is as the optical reactor 1. Even in this case, since the welding surfaces J . . . and the light guides C are formed, efficient light application is made possible to the fluid flowing through the glass tube 2. Therefore, the optical reactor can be used for such applications that an organic solvent in which margarine is dissolved in ethanol is allowed to flow so as to organize a trans isomer of the margarine component to change to a cis isomer on the short wavelength side and the like, and by volatilizing ethanol after such treatment, the trans isomer considered to be harmful can be removed.

FIG. 13 uses a double tube as the glass tube 2 in which the outer tube 2e and the inner tube 2i are disposed coaxially so that the light emitting portion 5 can be disposed at the center and the particles 3 . . . can be accommodated between the outer tube 2e and the inner tube 2i. Therefore, as illustrated in FIG. 13, by disposing the light emitting portion 5 such as a black light and the like at the center of the inner tube 2i and by filling the particles 3 . . . between the outer tube 2e and the inner tube 2i, the optical reactor 1 (water purifying device M) can be obtained. According to the optical reactor 1 in FIG. 13, since a light beam can be applied in directions of 360° from the light emitting portion 5 disposed at the center to each of the particles 3 . . . disposed in a ring shape, light application efficiency to the particles 3 . . . can be further improved.

FIG. 14 shows the glass tube 2 in which a porous body 51 is provided. In this case, by destroying the glass material so as to obtain the particles 3 . . . composed of random pieces and by filling these particles 3 . . . in the glass tube 2 and applying heating treatment to them so as to weld each of the particles 3 . . . together, the welding surfaces J . . . each having a predetermined area can be basically generated because of the principle similar to that when the above-described spherical particles 3 . . . are used. At this time, by ensuring the welded state as appropriate, porous spaces 52 . . . which form channels are obtained, and the more effective light guides C with less loss can be obtained.

FIGS. 15 to 18 illustrate modified sectional shape of the glass tube 2. In FIGS. 1 to 3, a circular shape is selected for the sectional shape of the glass tube 2, but in FIGS. 15 to 18, a non-circular shape is selected. First, in FIGS. 15(a) and 15(b), a polygon is selected for the sectional shape of the glass tube 2, and FIG. 15(a) shows that a square is selected and FIG. 15(b) shows that a triangle is selected. Even if the sectional shape of the glass tube 2 is changed, a change point is only the sectional shape and the other configurations may remain the same as the above-described embodiment illustrated in FIGS. 1 to 14. Moreover, if a polygon is selected for the sectional shape of the glass tube 2, integral molding is not necessarily needed, but as illustrated in FIG. 16, manufacture is possible by assembling a plurality of plate members. In the case of the square in FIG. 15(a), for example, four flat plate members 2sx, 2sx, 2sy, and 2sy are prepared as illustrated in FIG. 16, and each of the plate members 2sx . . . can be fixed (bonded) together through adhesive portions 61 . . . such as a transparent adhesive liquid or adhesive sheet and the like. As other fixing means, for example, each of the plate members 2sx . . . may be combined through projections and recesses for positioning and the periphery may be fixed by a fixing band or the like, thus the fixing means is arbitrary. In addition, the polygon includes various shapes such as a hexagon, a trapezoid, a diamond and the like.

On the other hand, FIGS. 17 and 18 show that as a sectional shape of the glass tube 2, an elongated shape whose long side Dm is three times or more of a short side Ds is selected, and FIG. 17 shows selection of a linear shape and FIG. 18 shows selection of a curved shape. By selecting an elongated shape for the sectional shape of the glass tube 2, an area on a large width surface in the long side Dm can be enlarged, and thus, the light can be efficiently applied to this large width surface. Moreover, by selecting such shapes, the optical reactor 1 having a small size in the width direction can be obtained.

As illustrated in FIGS. 15 to 18, by forming the sectional shape of the glass tube 2 as a non-circular shape and having at least a polygon, a linear or curved elongated shape whose long side is three times or more of the short side included in this non-circular shape, various applications and purposes and moreover, the types, shapes and the like of the light emitting portion 5 can be flexibly handled, whereby improvement and optimization of the treatment efficiency can be easily realized. In FIGS. 11 to 18, the same reference numerals are given to the same portions in FIGS. 1 to 3 so as to clarify the configurations.

The preferred embodiments (modified embodiments) have been described in detail, but the present invention is not limited to those embodiments and is capable of arbitrary change, addition or deletion within a range not departing from the gist of the present invention in the configuration, shape, material, quantity, numerical value and the like of details.

For example, as the material of the glass tube 2 and the material of the particles 3 . . . , an arbitrary glass material other than the exemplified can be used, and use of other transparent materials presenting the action similar to that of the glass material are not excluded. Moreover, the case in which the glass tube 2 is formed linearly (I-shape) is illustrated, but the glass tube may be formed by bending or curving the material so as to have an L-shape, a U-shape and the like as necessary. On the other hand, a light source radiating a wavelength suitable for the photocatalyst or reaction substance in use can be selected also for the light source lamp, and a light source other than the exemplified lamp is not excluded. Furthermore, the case in which the photocatalyst layer 4 is formed by using titanium dioxide is illustrated, but formation using other substances presenting an photocatalyst action is not excluded.

### INDUSTRIAL APPLICABILITY

The optical reactor 1 according to the present invention can be widely used for various optical reactors capable of having a fluid (liquid, gas) reacted with light or a light component and practically can be used for various devices provided with the optical reactor 1 in a part thereof such as the exemplified water purifying device, an air purifying device, a deodorizing device, a sterilizing device and the like.

1. An optical reactor configured such that a large number of particles formed of a glass material are accommodated in a glass tube, and a fluid can flow through the glass tube, characterized in that
a contact portion between the glass tube and the particles and a contact portion between the particles serve as welding surfaces each having a predetermined area so that light guides are provided continuing to the glass tube and the particles through the welding surfaces.

2. The optical reactor according to claim 1, wherein
an photocatalyst layer is provided on the surfaces of the particles and an inner surface of the glass tube except the welding surface.

3. The optical reactor according to claim 1, wherein
the glass tube is a single tube capable of applying a light beam to an outer peripheral surface from a light emitting portion outside.

4. The optical reactor according to claim 1, wherein
the glass tube is formed having a circular sectional shape.

5. The optical reactor according to claim 1, wherein
the glass tube is formed having a non-circular sectional shape, and this non-circular shape includes at least a polygon, a linear or curved elongated shape whose long side is three times or more of the short side.

6. The optical reactor according to claim 1, wherein
the glass tube is a double tube in which an outer tube and an inner tube are disposed coaxially so that a light emitting portion can be disposed at the center and the particles can be accommodated between the outer tube and the inner tube.

7. The optical reactor according to claim 1, wherein
the particles are formed of a single glass material.

8. The optical reactor according to claim 1, wherein
each of the particles has, on the surface of a base material formed of a single glass material, a coating layer made of a transparent material having a melting point lower than that of the glass material provided.

9. The optical reactor according to claim 1, wherein
each of the particles is formed having a spherical shape with the same diameter.

10. The optical reactor according to claim 2, wherein
the optical rector is used in a water purifying device in which one end of the glass tube becomes an inlet for water to be treated and the other end becomes an outlet of treated water.

11. A method for manufacturing an optical reactor configured such that a large number of particles formed of a glass material are accommodated in a glass tube, and a fluid can flow through the glass tube, characterized in that
after the particles are filled in the glass tube, the glass tube filled with the particles is heated at a predetermined heating temperature so that welding surfaces each having a predetermined area are generated on a contact portion between the glass tube and the particles and a contact portion between the particles and light guides continuing to the glass tube and the particles are provided through the welding surfaces.

12. The method for manufacturing an optical reactor according to claim 11, wherein
after the welding surfaces are generated on the contact portion between the glass tube and the particles and the contact portion between the particles, an photocatalyst solution is filled in the glass tube and after that, the photocatalyst solution is discharged from the glass tube, and an photocatalyst layer is provided on the surfaces of the particles and an inner surface of the glass tube except the welding surfaces.

13. The method for manufacturing an optical reactor according to claim 11, wherein
the welding surfaces are generated directly on the surfaces of particles formed of a single glass material.

14. The method for manufacturing an optical reactor according to claim 11, wherein
a material having a melting point higher than that of the material for the particles is used for the glass tube.

15. The method for manufacturing an optical reactor according to claim 11, wherein
each of the particles has, on the surface of a base material formed of a single glass material, a coating layer made of a transparent material having a melting point lower than that of the glass material provided, and the welding surfaces are generated by the coating layer.

16. The optical reactor according to claim 2, wherein
the glass tube is a single tube capable of applying a light beam to an outer peripheral surface from a light emitting portion outside.

17. The optical reactor according to claim 2, wherein
the glass tube is formed having a circular sectional shape.

18. The optical reactor according to claim 3, wherein
the glass tube is formed having a circular sectional shape.

19. The optical reactor according to claim 2, wherein
the glass tube is formed having a non-circular sectional shape, and this non-circular shape includes at least a polygon, a linear or curved elongated shape whose long side is three times or more of the short side.

20. The optical reactor according to claim 3, wherein
the glass tube is formed having a non-circular sectional shape, and this non-circular shape includes at least a polygon, a linear or curved elongated shape whose long side is three times or more of the short side.
